(19) United States
(12) Patent Application Publication
(10) Pub. No.: US 2024/0123558 A1
(43) Pub. Date: Apr. 18, 2024

(54) WORKTOP JIG

(71) Applicant: SCRIBEMASTER LIMITED, Dover (GB)

(72) Inventor: Colin Roy DAVEY, Dover (GB)

(73) Assignee: SCRIBEMASTER LIMITED, Dover (GB)

(21) Appl. No.: 18/279,081

(22) PCT Filed: Feb. 4, 2022
(86) PCT No.: PCT/EP2022/052773

§ 371 Date: Aug. 28, 2023

(30) Foreign Application Priority Data
Feb. 5, 2021 (GB) 2101663.9

(51) Int. Cl. B23Q 1/62; B23Q 9/00; B25H 1/00

(52) U.S. Cl. CPC B23Q 1/62; B23Q 9/00; B25H 1/00

(57) ABSTRACT

A worktop jig comprising a jig frame, wherein the jig frame comprises a pair of opposed end members and a pair of opposed side members; the opposed end members and the opposed side members together define a rectangular aperture within the jig frame; the opposed end members and the opposed side members each define an upwardly facing surface and the upwardly facing surfaces are arranged to lie in a common plane; and each of the opposed side members defines a downwardly facing surface, wherein each side member downwardly facing surface carries an angled elongate base element, whereby when the angled base elements of the worktop jig are located on a planar substrate, the common plane of the jig frame is angled with respect to the plane of the substrate

### CROSS-REFERENCE TO RELATED APPLICATIONS

The present application is a national phase application of PCT Application No. PCT/EP2022/052773, filed Feb. 4, 2022, entitled “WORKTOP JIG”, which claims the benefit of Great Britain Patent Application No. 2011663.9, filed Feb. 5, 2021, each of which is incorporated by reference in its entirety.

### BACKGROUND OF THE INVENTION

### 1. Field of the Invention

The present invention relates to a jig that is suitable for cutting worktops or counters.

### 2. Description of the Related Art

In situations in which a sink for a kitchen does not include an integral drainer, it is usually desirable to create a drainer in the worktop or counter adjacent to the sink, such that water is able to run off from the drainer portion of the worktop/counter into the sink.

### SUMMARY OF THE INVENTION

The present invention provides a single jig which can be used to cut multiple different designs of drainer into a worktop or counter.

According to a first aspect of the invention, there is provided a worktop jig comprising a jig frame, wherein the jig frame comprises a pair of opposed parallel end members and a pair of opposed parallel side members; the opposed end members and the opposed side members together define a rectangular aperture within the jig frame; the opposed end members and the opposed side members each define an upwardly facing surface and the upwardly facing surfaces are arranged to lie in a common jig plane; and each of the opposed side members defines a downwardly facing surface, wherein each side member downwardly facing surface carries an angled (i.e. sloping) elongate base element, whereby when the angled base elements of the worktop jig are located on a planar substrate, the common jig plane of the jig frame is angled with respect to the plane of the substrate.

The skilled person will appreciate that a cutting tool, for example a powered cutting tool such as a router, may be carried parallel to the common jig plane. Such a tool is thereby angled relative to the plane of the substrate and can cut a surface, grooves, slots, etc. which slope relative to the substrate plane.

In the context of the present invention, the term “angled” means that the common jig plane subtends an angle relative to a planar substrate upon which the jig is placed. The angle is suitably from 2° to 30°. For example, the angle between the common jig plane and the substrate plane may be from 2° to 20°, such as 2° to 10°.

The skilled person will appreciate that the angled elongate base elements suitably are aligned and suitably have the same slope profile such that the worktop jig does not wobble or rock relative to a planar substrate surface.

In order for a tool to be used relative to the jig, the worktop jig may further include a tool guide component. Thus, according to an embodiment of the invention, the upwardly facing surface of each of the opposed side rails defines or carries one part of a two-part slidable coupling. The tool guide component may include a second part of the two-part slidable coupling, wherein the tool guide component may be slidably coupled to the jig frame via the two-part coupling.

The second part of the two-part coupling may comprise a carriage and the first part of the two-part coupling may comprise a track along which the carriage runs. The track may be in the form of a groove or channel within which the carriage runs, or it may comprise a projecting, rail-like element relative to which the carriage is able to move longitudinally.

The first part of the two-part coupling (e.g. the track) suitably includes an end stop which defines a limit of travel for the carriage. Optionally, the first part of the two-part coupling includes a pair of opposed end stops which constrain the longitudinal movement of the carriage relative to the first part of the two-part coupling.

In a further embodiment, the worktop jig may include one or more detachable intermediate stops, which may be coupled to the first part of the two-part coupling, or coupled to one or both of the side members of the jig frame adjacent to the first part of the two-part coupling, in order to constrain further the allowable movement of the tool guide component relative to the jig frame.

In an embodiment of the invention, the jig includes a tool guide component in the form of a two-dimensional tool holder comprising a pair of parallel rails and a tool receiving element, wherein at one end of the parallel rails is provided a first carriage; at the opposite end of the parallel rails is provided a second carriage; the first carriage is slidably coupled to a first track defined or carried by one of the side members; the second carriage is slidably coupled to a second track defined or carried by the other of the side members; and the tool receiving element is slidably coupled to the pair of parallel rails, wherein the tool receiving element is capable of moving in two dimensions relative to the jig frame. The skilled person will appreciate that the tool receiving element is suitably coupled to the pair of parallel rails such that it slides longitudinally along the rails.

The tool receiving element suitably defines one or more connecting elements in order to couple a tool, such as a power tool, for example an electric router, to the tool receiving element.

The skilled person will appreciate that first ends of both of the parallel rails are coupled to the first carriage and second ends of both of the parallel rails are coupled to the second carriage. In this way, the first and second carriages (and therefore also the parallel rails together) slide relative to the jig frame in a first dimension and the tool receiving element suitably slides relative to the parallel rails in a second dimension, transverse to the first dimension, such that the tool receiving element is moveable relative to the jig frame in two dimensions (the “X” and “Y” dimensions), which are both parallel to the common jig plane.

When the opposed side members each define a track in the form of a groove or channel, each of the first and second carriages may include respective runners which may be located within a respective one of the grooves or channels. Alternatively, when the opposed side members each carry a respective track in the form of projecting, elongate (rail-like) element, each carriage may include a receiver which slidably receives a respective one of the elongate elements. Optionally, the slidable coupling may include one or more bearings, races or wheels in order to reduce friction within the coupling.

In an embodiment of the invention, each of the opposed side members defines a track in the form of an elongate linear channel, each carriage defines one or more runners, and each of the runners is located within and slidably coupled to a respective one of the channels.

It may be desirable to move a tool only in a single dimension (e.g. the X dimension). Accordingly, the two-dimensional tool holder may include a clamp component which is capable of clamping the tool receiving element relative to the parallel rails. Thus, the clamp may prevent longitudinal movement of the tool receiving element relative to the parallel rails. The clamp component may have a free configuration in which the tool receiving element is able to slide relative to the parallel rails, and a locked configuration in which the tool receiving element is prevented from movement relative to the parallel rails.

In a further embodiment of the invention, the tool guide component is detachable from the jig frame.

In a still further embodiment of the invention, each of the opposed end members and/or the opposed side members defines a locating ledge which extends into the aperture. A skilled person may wish to employ a template with the jig. The template is suitably located within the rectangular aperture defined by the jig frame. In such cases, the template may be supported by the locating ledges defined by the opposed end members and/or the opposed side members.

By having the tool guide component detachable from the jig frame, the tool guide component would not interfere in the use of a template located within the aperture defined by the jig frame.

It is desired to maintain the angle between the jig frame and the substrate. Accordingly, the jig members are suitably sufficiently rigid that they resist flexing in use. For example, the jig members (i.e. the opposed side members and the opposed end members) may be formed from a metal, such as aluminium or steel, or they may be formed from a rigid polymer, such as ABS or polycarbonate for example.

According to a second aspect of the invention, there is provided a kit comprising a worktop jig as defined anywhere herein and one or more templates, wherein the or each template is sized and configured for location within the rectangular aperture defined by the jig frame; and wherein the or each template includes a respective array of slots and/or holes.

By providing a kit according to the second aspect of the invention, a user can use the jig to cut “freeform” shapes into a worktop or counter. Alternatively, the user can locate a template within the aperture defined by the jig frame and cut a predetermined array of shapes into the worktop or counter.

The skilled person will appreciate that the or each template has a rectangular shape to fit within the aperture defined by the jig frame members.

In an embodiment of the invention, each of the opposed end members and/or the opposed side members of the jig frame defines or includes a locating ledge which extends into the aperture, and the or each template is supported by the locating ledges. Accordingly, the template may be supported on two opposing sides or on all four sides.

Suitably, the kit includes two or more separate templates, wherein the array of slots and/or holes of a first template is different to the array of slots and/or holes of the second template. The kit may include three, four, five, six, seven, eight, nine, ten or more templates, wherein each template defines an array of slots and/or holes which is different to the other templates.

When in use, it may be desired to secure the jig to a substrate to be cut. Accordingly, the kit may further include one or more clamps to clamp the worktop jig to a substrate.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

### BRIEF DESCRIPTION OF THE DRAWINGS

An embodiment of the invention will now be described, by way of example only, with reference to the accompanying drawings in which:

FIG. 1 is a plan view from above of a worktop jig according to an embodiment of the invention;

FIG. 2 is a plan view from below of the jig shown in FIG. 1;

FIG. 3 is a plan view from above of the tool guide component shown in FIGS. 1 and 2;

FIG. 4 is a plan view from below of the tool guide component shown in FIG. 3;

FIG. 5 is a perspective view of the worktop jig clamped in location relative to a worktop substrate;

FIG. 6 is a cross-sectional view vertically through the end members of the worktop jig and worktop substrate shown in FIG. 5;

FIG. 7 is a cross-sectional view vertically through the side members of the worktop jig and worktop substrate shown in FIG. 5;

FIG. 8 shows a tool guide component and an attached router slidably coupled to the worktop jig shown in FIG. 5;

FIG. 9 shows the worktop substrate after having been cut by the worktop jig shown in FIG. 8;

FIG. 10 shows a first template for use with the worktop jig shown in FIG. 5;

FIG. 11 shows a second template in combination with the worktop jig shown in FIG. 5;

FIG. 12 shows the combination shown in FIG. 11 located over a worktop substrate;

FIG. 13 shows a router being used with the combination shown in FIG. 12; and

FIG. 14 shows the worktop substrate after having been cut by the router shown in FIG. 13.

### DETAILED DESCRIPTION

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

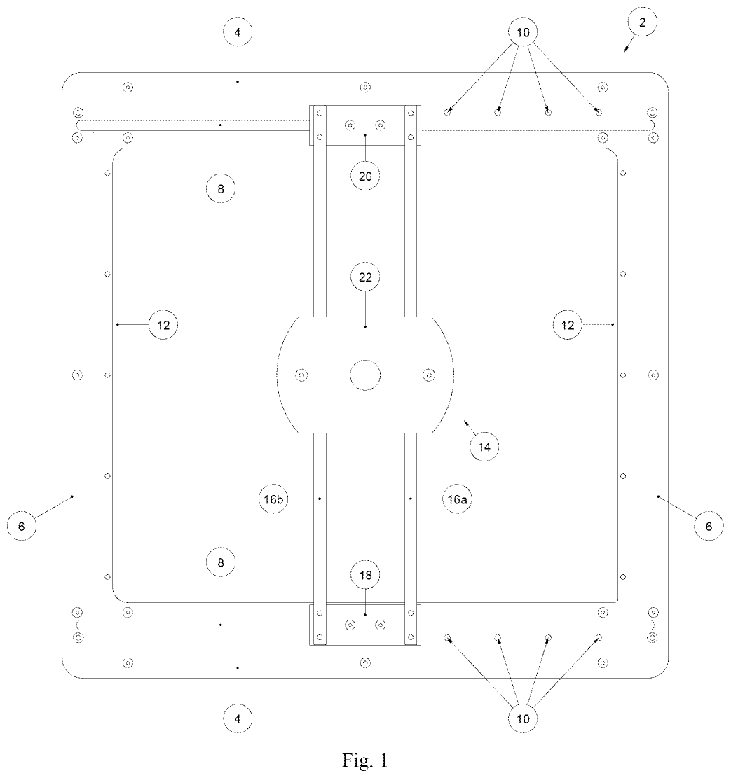

As shown in FIG. 1, a worktop jig 2 is provided which comprises a pair of opposed side frame members 4 and a pair of opposed end frame members 6 which together define a rectangular jig frame having a rectangular aperture which is framed by the side and end frame members 4, 6.

Each of the side frame members 4 define a respective elongate linear channel 8 which forms one part of a two-part slidable coupling. Each of the linear channels 8 define end stops at each end of the channel 8. However, each side panel further defines a plurality of bores 10 into which adjustable end stop elements (e.g. pegs) may be located to define end stops other than the end of each channel 8.

Each of the end frame members 6 include a ledge 12 which extends into the aperture defined by the side and end frame members 4, 6. The purpose of the ledges 12 will be discussed in more detail below.

The worktop jig 2 shown in FIG. 1 further includes a tool guide component 14 in the form of a two-dimensional tool holder. The tool guide component 14 includes a pair of spaced apart, parallel rails 16a, 16b. A first carriage 18 is provided at a first end of both of the rails 16a, 16b and the first ends of the rails 16a, 16b are secured to the first carriage 18. A second carriage 20 is provided at the opposite end of both of the rails 16a, 16b and the second ends of the rails are secured to the second carriage 20. The first and second carriages 18, 20 are slidably engaged with a respective one of the channels 8 as discussed below.

A tool receiving element 22 is slidably coupled to the pair of rails 16a, 16b such that the tool receiving element 22 is capable of sliding longitudinally along the rails 16a, 16b. As the carriages 18, 20 are capable of sliding longitudinally along the channels 8 in a first direction of travel and the tool receiving element 22 is capable of sliding relative to the rails 16a, 16b is a second direction of travel, which is perpendicular to the first direction of travel, the tool receiving element 22 is capable of moving within a plane which is parallel to a place defined by the jig frame. Thus, the tool receiving element 22 is capable of moving in 2 dimensions.

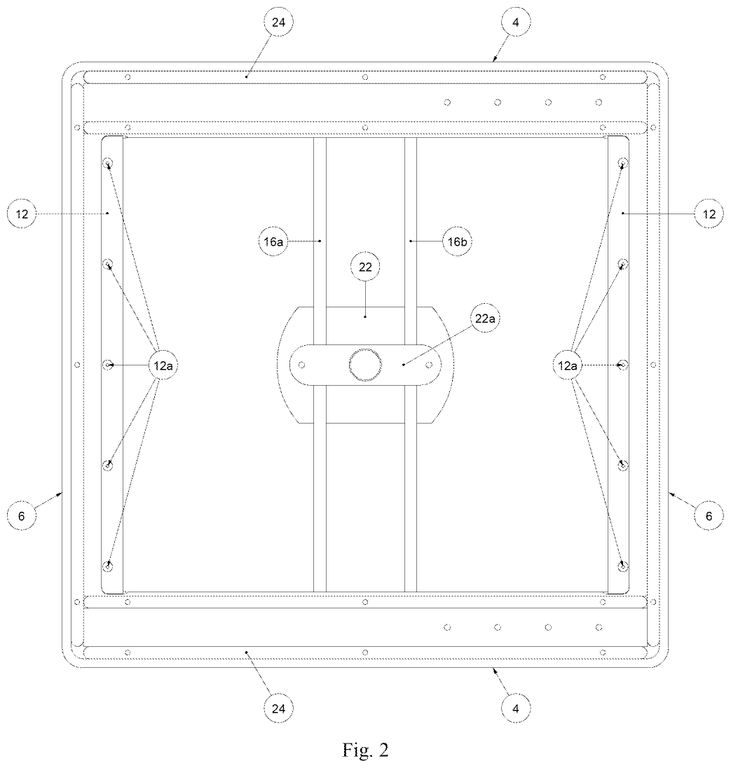

FIG. 2 shows The worktop jig 2 from below. In this figure, it can be seen that the tool receiving element 22 is coupled to the rails 16a, 16b via a clamping element 22a, which defines therein a pair of semi-circular bearing portions, which permit the tool receiving element 22 to slide along the rails 16a, 16b, but prevents transverse displacement of the tool receiving element 22 relative to the rails 16a, 16b.

Also shown in FIG. 2 are a pair of angled base elements 24. The angled base elements 24 define a gradual slope from one end of each base element 24 to the opposite end, which in turn angles the jig frame relative to a planar surface upon which it is located. The angled base elements are detachably secured to the side frame members 4 via screws. In this way, the angle subtended between the jig frame and the substrate to which it is attached may be changed by changing the angled base elements 24 to base elements which define a different angle of slope from one end to the other end.

Finally, FIG. 2 shows the ledges 12 which are attached to their respective end frame members 6 via screws 12a.

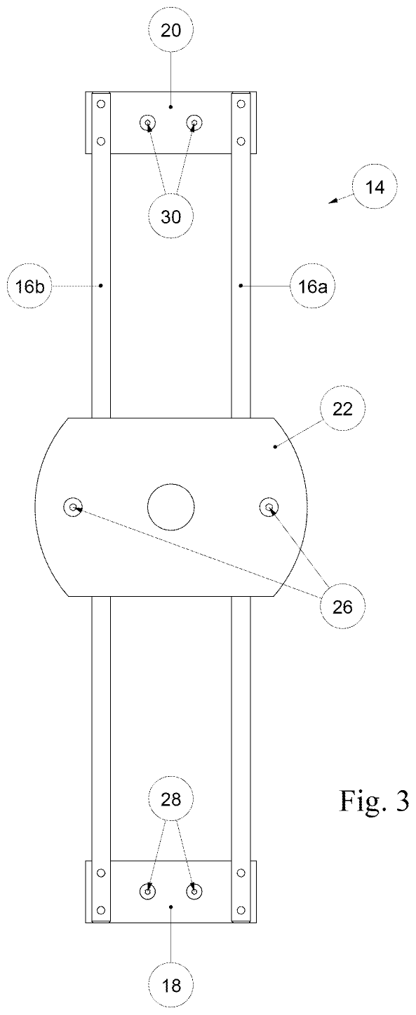

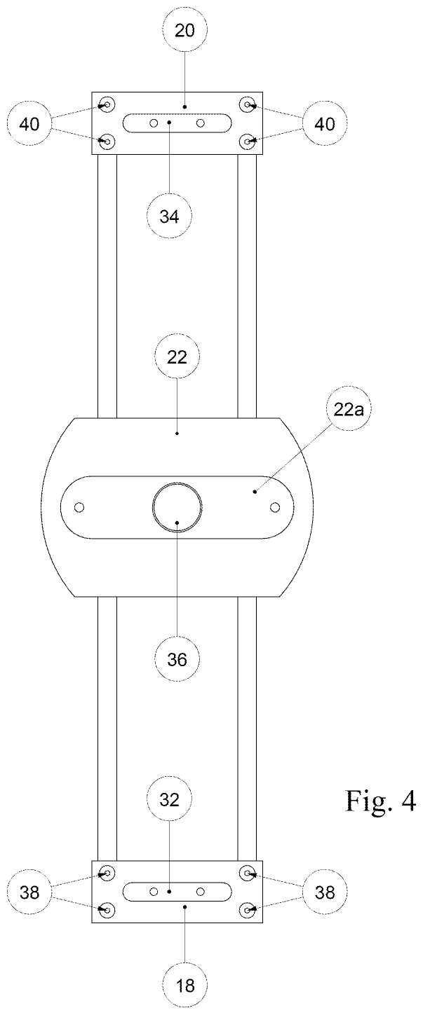

FIGS. 3 and 4 show the tool guide component 14 in more detail. Screws 28 of the first carriage 18 secure to a first runner 32 to the underside of the carriage 18. Similarly, screws 30 of the second carriage 20 secure a second runner 34 to the underside of the second carriage 20. The runners 32, 34 slide within the respective channels 8. In order to minimise friction between the runners 32, 34 and their respective channels 8, the runners 32,34 may be formed from a polymer, such as PTFE or from a metal, such as aluminium.

The first carriage 18 is secured to the first ends of the rails 16a, 16b via screws 38. Similarly, the second carriage 20 is secured to the second ends of the rails 16a, 16b via screws 40.

Screws 26 secure the clamping element 22a to the underside of the tool receiving element 22. In addition, a thumbwheel 36 is able to vary the friction between the rails 16a, 16b and the combination of the tool receiving element 22 and the clamping element 22a. Thus, the thumbwheel 36 may be set to minimise the friction and thereby permit the tool receiving element 22 to slide along the rails 16a, 16b, or it may be set to maximise the friction between the rails 16a, 16b and the combination of the tool receiving element 22 and the clamping element 22a such that the tool receiving element is prevented from movement relative to the rails 16a, 16b.

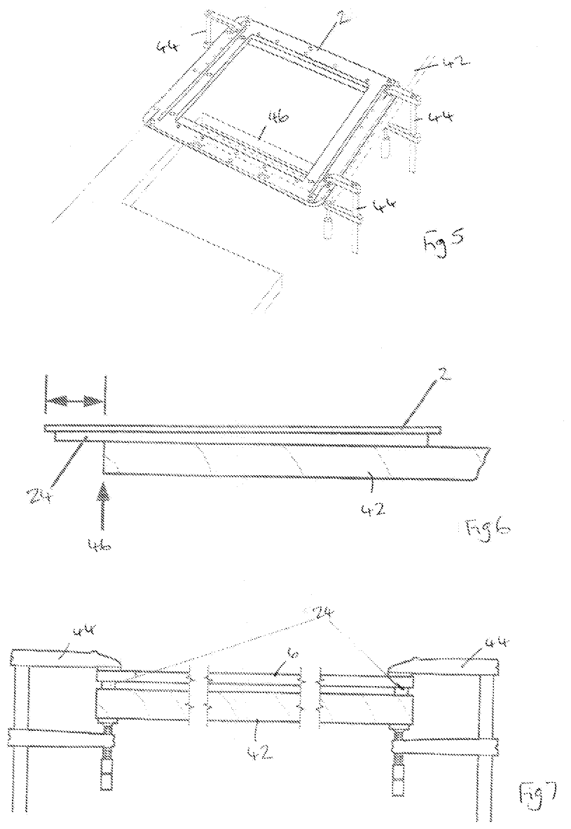

FIGS. 5, 6 and 7 show the worktop jig 2 clamped to a worktop or counter substrate 42 via clamps 44. The tool guide component 14 has been removed from the jig 2 at this point, as it is easier to clamp the jig 2 in the desired location with the tool guide component 14 removed. As can be seen in FIG. 6, the angled base elements 24 result in a slope of the plane of the jig frame relative to the plane of the upper surface of the worktop substrate 42. Furthermore, the jig is located such that aperture defined by the jig frame extends beyond an edge 46 of the substrate. In this way, a cutting tool, such as a router, carried by the tool receiving element 22 can cut up to the edge 46 of the worktop substrate 42.

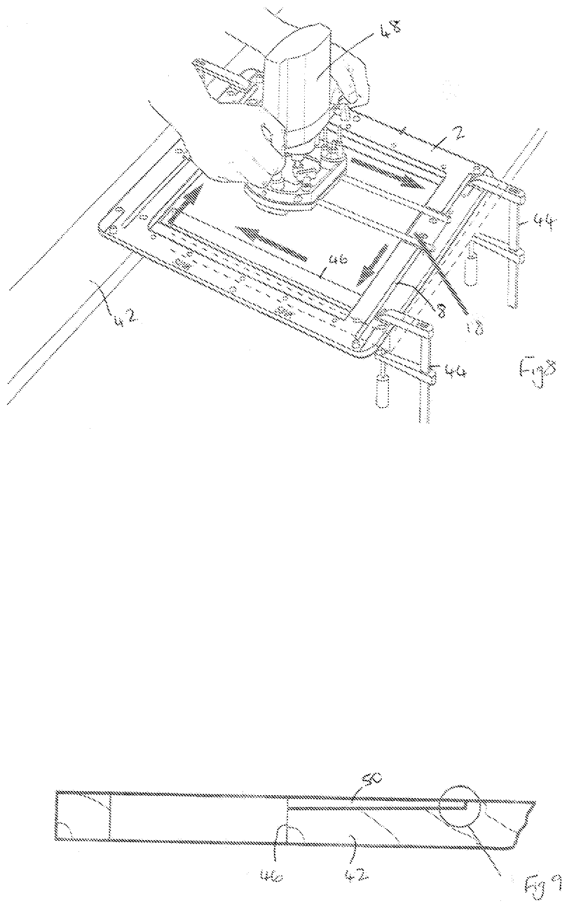

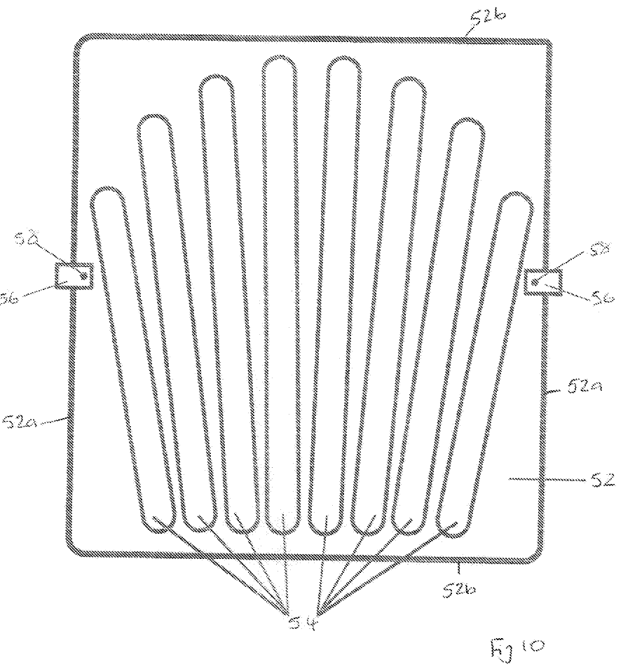

FIG. 8 shows the worktop jig in action. An electric router 48 has been attached to the tool receiving element 22 and the tool guide element 14 has been coupled to the jig frame such that the runners 32, 34 are slidably carried within their respective channels 8. In this arrangement, a user is able to move the router 48 in tow dimensions within the rectangular aperture defined by the jig frame, thereby cutting a sloping cavity 50 into the worktop substrate. As can be seen in FIG. 9, the cavity 50 slopes downwards towards the edge 46 of the substrate.

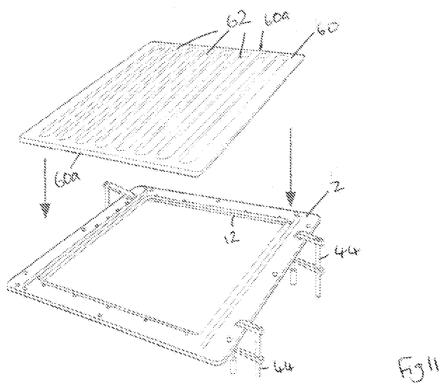

FIG. 10 shows a first template 52 which can be used in combination with the jig frame 2 with the tool guide component 14 removed.

The template 52 defines a pair of opposed side portions 52a and a pair of opposed end portions 52b. It also defines a plurality of elongate slots 54. In use, the opposed end portions 52b of the template 52 are supported by the ledges 12 such that the top surface of the template 52 is flush with the upwardly facing surface of the jig frame. In order to prevent the template bowing downwards in its middle portion, optional support tabs 56 are screwed to the template 52 via screws 58. These support tabs 56 contact the upwardly facing surfaces of the opposed side frame members 4 and maintain the template 52 in a planar configuration.

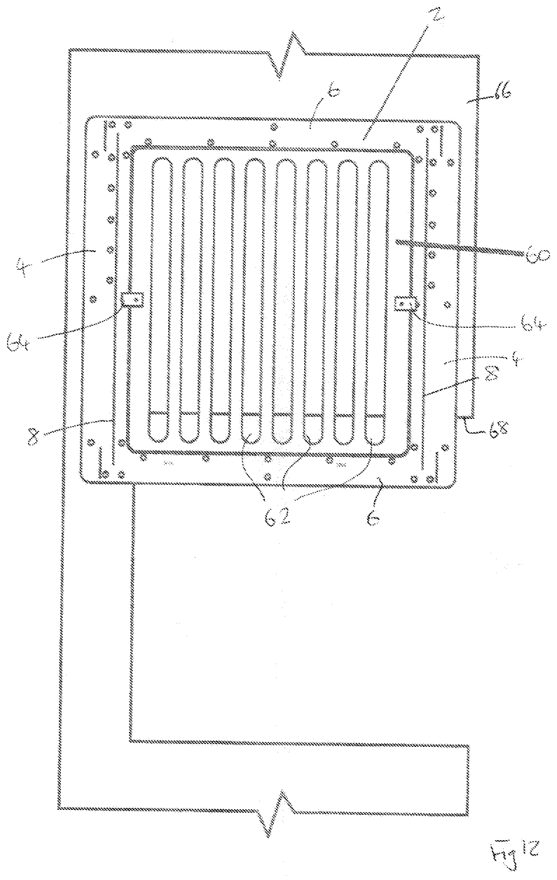

FIGS. 11 and 12 show a second template 60 which can be used in combination with the jig frame 2. The template 60 defines a different array of slots 62 than the template 52 shown in FIG. 10. The template 60 is located within the aperture defined by the jig frame and is supported at its ends 60a by the ledges 12. When the template 60 is located within the aperture, a pair of support tabs 64 are screwed to the template, such that portions of the support tabs contact the side frame members 4 of the jig frame (shown in FIG. 12).

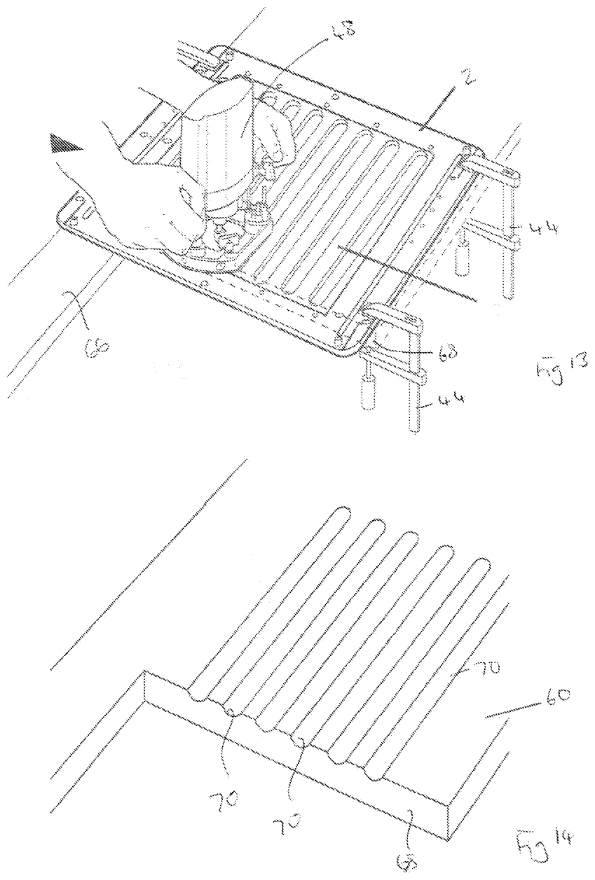

As shown in FIG. 12, the jig 2 with the attached template 60 is located in position over a worktop substrate 66, such that the slots 62 extend beyond an edge portion 68 of the substrate 66. The jig 2 is then clamped in the desired position via clamps 44 (as shown in FIG. 13).

FIG. 13 shows the router 48 in use with the jig 2 and template 60 shown in FIG. 12. In this case, rather than cutting out a sloping cavity, the router cuts straight slots into the worktop substrate 66. For example, when a rounded router cutter bit is used, concave slots 70 are formed in the substrate 66, as shown in FIG. 14.

The skilled person will appreciate that the concave slots 70 may be cut into the sloping cavity 50 (shown in FIG. 9) such that both the slots 70 and the lands between the slots 70 slope to aid with water draining towards a sink.

The skilled person will appreciate that a kit according to the second aspect of the invention may contain the worktop jig comprising the jig frame, the detachable tool guide component 14 and one or more templates. Additionally, the kit may comprise two or more sets of angled base elements, wherein each set of base elements defines a different angle of slope.

1. A worktop jig comprising a jig frame, wherein the jig frame comprises a pair of opposed end members and a pair of opposed side members; the opposed end members and the opposed side members together define a rectangular aperture within the jig frame; the opposed end members and the opposed side members each define an upwardly facing surface and the upwardly facing surfaces are arranged to lie in a common plane; and each of the opposed side members defines a downwardly facing surface, wherein each side member downwardly facing surface carries an angled elongate base element, whereby when the angled base elements of the worktop jig are located on a planar substrate, the common plane of the jig frame is angled with respect to the plane of the substrate; and wherein the upwardly facing surface of each of the opposed side rails defines or carries one part of a two-part slidable coupling.

2. A worktop jig according to claim 1, wherein the one part of the two-part coupling is a recessed groove or a projecting elongate element.

3. A worktop jig according to claim 1, wherein each of the opposed end members and/or the opposed side members defines a locating ledge which extends into the aperture.

4. A worktop jig according to claim 1, wherein the jig further includes a two-dimensional tool holder comprising a pair of parallel rails and a tool receiving element, wherein at one end of the parallel rails is provided a first carriage; at the opposite end of the parallel rails is provided a second carriage; the first carriage is slidably coupled to one of the side members; the second carriage is slidably coupled to the other of the side members; and the tool receiving element is slidably coupled to the pair of parallel rails, wherein the tool receiving element is capable of moving in two dimensions relative to the jig frame.

5. A worktop jig according to claim 4, wherein the two-dimensional tool holder is detachable from the jig frame.

6. A worktop jig according to claim 4, wherein the two-dimensional tool holder includes a clamp element to clamp the tool receiving element relative to the parallel rails.

7. A worktop jig according to claim 4, wherein each side member defines an elongate linear channel, each carriage defines one or more runners, and the runners are slidably coupled to the channels.

8. A kit comprising a worktop jig and one or more templates, wherein the worktop jig comprises a jig frame, wherein the jig frame comprises a pair of opposed end members and a pair of opposed side members; the opposed end members and the opposed side members together define a rectangular aperture within the jig frame; the opposed end members and the opposed side members each define an upwardly facing surface and the upwardly facing surfaces are arranged to lie in a common plane; and each of the opposed side members defines a downwardly facing surface, wherein each side member downwardly facing surface carries an angled elongate base element, whereby when the angled base elements of the worktop jig are located on a planar substrate, the common plane of the jig frame is angled with respect to the plane of the substrate; wherein the upwardly facing surface of each of the opposed side rails defines or carries one part of a two-part slidable coupling; and wherein the or each template is sized and configured for location within the rectangular aperture defined by the jig frame; and wherein the or each template includes an array of slots and/or holes.

9. A kit according to claim 8, wherein each of the opposed end members and/or the opposed side members defines a locating ledge which extends into the aperture, and the or each template is supported by the locating ledges.

10. A kit according to claim 8, wherein the kit includes one or more support tabs and the or each template is supported by the jig frame via the or each support tab.

11. A kit according to claim 8, wherein the kit includes two or more different templates, wherein the array of slots and/or holes of a first template is different to the array of slots and/or holes of the second template.

12. A kit according to claim 8, wherein the kit further includes one or more clamps to clamp the worktop jig to a substrate.
